(19) United States
(12) Patent Application Publication
(10) Pub. No.: US 2023/0074012 A1
(43) Pub. Date: Mar. 9, 2023

(54) CARBON DIOXIDE EMISSIONS TRADING METHOD, EMISSIONS TRADING SYSTEM, AND MOVING BODY

(71) Applicant: KABUSHIKI KAISHA TOSHIBA, Tokyo (JP)

(72) Inventor: Masaaki ISHIDA, Kawasaki Kanagawa (JP)

(73) Assignee: KABUSHIKI KAISHA TOSHIBA, Tokyo (JP)

(21) Appl. No.: 17/682,155

(22) Filed: Feb. 28, 2022

(30) Foreign Application Priority Data
Sep. 9, 2021 (JP) 2021-146935

(51) Int. Cl. G06Q 40/04; G06Q 30/00; G06Q 50/30

(52) U.S. Cl. CPC G06Q 40/04; G06Q 30/018; G06Q 50/30

(57) ABSTRACT

According to one embodiment, a carbon dioxide emissions trading method includes acquiring position data of a moving body and a first CO₂ emission amount emitted by the moving body during traveling, specifying one region, where the moving body is traveling, of a plurality of regions divided in terms of rights as a trading target region based on the position data and the first CO₂ emission amount and obtaining a second CO₂ emission amount emitted by the moving body in the trading target region, setting a cost corresponding to the second CO₂ emission amount as a consideration of an emission right based on scheme information in the trading target region, and trading the emission right based on the cost corresponding to the second CO₂ emission amount.

### CROSS-REFERENCE TO RELATED APPLICATIONS

This application is based upon and claims the benefit of priority from Japanese Patent Application No. 2021-146935, filed Sep. 9, 2021, the entire contents of which are incorporated herein by reference.

### FIELD

Embodiments described herein relate generally to an emissions trading method for carbon dioxide (CO₂) emitted by a moving body, an emissions trading system, and a moving body.

### BACKGROUND

A carbon dioxide (CO₂) emission amount in the transportation sector (automobiles, ships, and aircraft) accounts for 19% of total domestic CO₂ emission amount (2018). As measures for reducing the emission amount, the utilization of an economic method is performed as well as fuel consumption improvement, the utilization of fuel (biofuel) with less CO₂ emission, electrification, the improvement of an operation method, a change (modal shift) to transportation means with less CO₂ emission amount per transportation amount, and the like.

The economic method is a measure for encouraging CO₂ emission reduction by pricing CO₂ and imposing an economic burden according to the emission amount, and is collectively referred to as carbon pricing. As a main measure of carbon pricing, there are a “carbon tax” that imposes a tax according to the CO₂ emission amount, and an “emissions trading scheme” in which the excess or deficiency of CO₂ emission is traded between countries or between companies.

In Japan, a carbon tax is introduced as a “global warming countermeasure tax”, but the tax rate is at an extremely low level as compared with other countries. In addition, an emission amount trading scheme has been only introduced in some local governments, and has not been realized as a national system. Internationally, for example, in an aviation sector, it has been decided to introduce “Global Market Based Measures (GMBM)” utilizing market mechanisms. The GMBM obliges an airline company to purchase an emission right for the subsequent increase in the emission amount with respect to the actual CO₂ emission amount in 2020, which is a strong measure to achieve a goal.

On the other hand, in the case of international marginal transportation which accounts for about 2% of all global CO₂ emission amounts, a flag ship of convenience (a ship registered in a country different from the country in which a ship owner is located) is usually used due to tax, and there are a large number of transportations between third countries as well as between the country of the substantial ship owner and another country. For this reason, there is a problem that it is difficult to grasp the location of the responsibility regarding CO₂ emission, and economic measures such as those in the aviation sector are not utilized at present.

### BRIEF DESCRIPTION OF THE DRAWINGS

FIG. 1 is a diagram for explaining a carbon dioxide emissions trading method according to an embodiment.

FIG. 2 is a diagram schematically illustrating a configuration of an emissions trading system according to the embodiment.

FIG. 3 is a block diagram illustrating a functional configuration of a moving body in the embodiment.

FIG. 4 is a block diagram illustrating a functional configuration of a server according to the embodiment.

FIG. 5 is a diagram which is provided in a storage device of the server and illustrates scheme information regarding an emissions trading scheme.

FIG. 6 is a diagram illustrating an example of a travel route of the moving body.

FIG. 7 is a diagram illustrating an example of a hardware configuration of the server.

FIG. 8 is a flowchart illustrating a flow of emission right acquisition processing in the emissions trading system.

### DETAILED DESCRIPTION

In general, according to one embodiment, a carbon dioxide emissions trading method includes: acquiring position data indicating a current position of a moving body and a first CO₂ emission amount indicating an amount of CO₂ emitted by the moving body during traveling; specifying one region, where the moving body is traveling, of a plurality of regions divided in terms of rights as a trading target region based on the position data and the first CO₂ emission amount and obtaining a second CO₂ emission amount indicating an amount of CO₂ emitted by the moving body in the trading target region; setting a cost corresponding to the second CO₂ emission amount as a consideration of an emission right based on scheme information regarding emissions trading in the trading target region; and trading the emission right between a CO₂ emission manager and the trading target region based on the cost corresponding to the second CO₂ emission amount.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. Further, in the specification and drawings, corresponding elements are denoted by like reference numerals, and a detailed description thereof may be omitted unless otherwise necessary.

Hereinafter, a trading method for an emission right of carbon dioxide to be emitted when a moving body travels in a plurality of regions will be described.

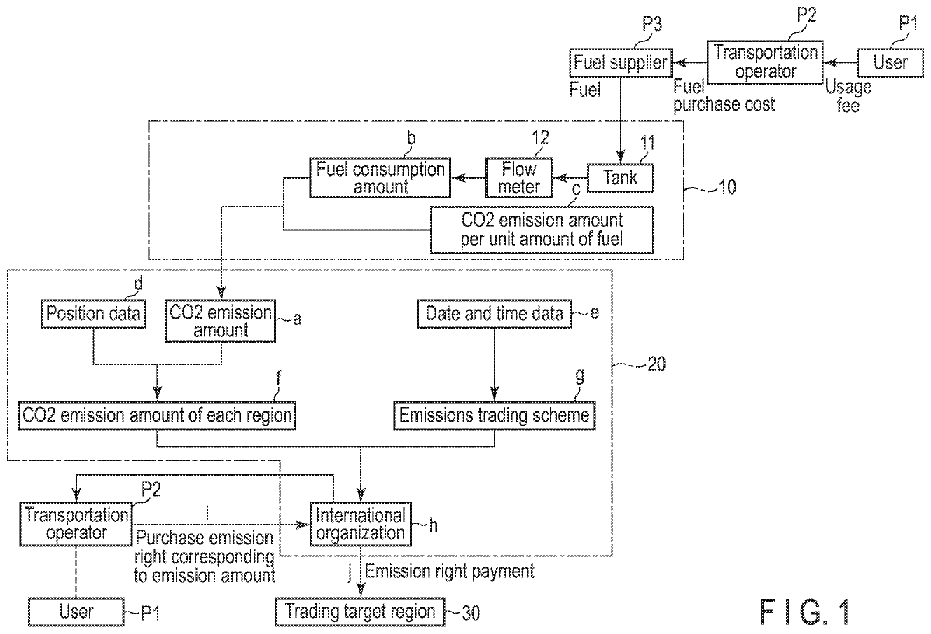

FIG. 1 is a diagram for explaining a carbon dioxide emissions trading method according to an embodiment. In the drawing, P1 represents a user, P2 represents a transportation operator, and P3 represents a fuel supplier. The user P1 holds a load or the like to be transported. The user P1 pays a usage fee to the transportation operator P2 when transporting the load or the like by using the moving body 10. The transportation operator P2 is a manager who manages a transportation service using the moving body 10. When the moving body 10 travels, the transportation operator P2 pays a fuel purchase cost to the fuel supplier P3.

The moving body 10 is, for example, a ship, and travels by operation of the transportation operator P2. CO₂ (carbon dioxide) is emitted when the moving body 10 travels by engine driving. The CO₂ emission amount at this time is referred to as a “first CO₂ emission amount a”. The first CO₂ emission amount a is equal to a value obtained by multiplying a consumption amount b of fuel by a CO₂ emission amount c per unit amount of the fuel (a=b×c). The fuel consumption amount b is measured by a flow meter 12. The CO₂ emission amount c per unit amount of fuel is measured in advance according to the type of fuel.

Here, in this embodiment, a server (server computer) 20 for trading CO₂ emission rights is provided on a cloud. The server 20 has a function of specifying a region where the moving body 10 is traveling as a trading target region among a plurality of regions divided in terms of rights and obtaining the amount of CO₂ emitted by the moving body 10 in the trading target region based on the first CO₂ emission amount a transmitted from the moving body 10 and position data d indicating the current position of the moving body 10. The amount of CO₂ emitted by the moving body 10 in the trading target region is referred to as a “second CO₂ emission amount f”.

The position data d can be obtained in real time by using a position information service such as a global positioning system (GFS). The trading target region 30 in which the moving body 10 is traveling can be specified from the position data d, and the second CO₂ emission amount f can be obtained by integrating the first CO₂ emission amount a emitted while the moving body 10 is traveling in the trading target region 30.

The server 20 has a function of an international organization h that performs trading of CO₂ emission rights by using an emissions trading scheme g of each region. Incidentally, in the example of FIG. 1, the server 20 has the function of the international organization h, but the function of the international organization h may be realized by another server.

The emissions trading scheme g includes a trading price of an emission right determined for each region. The international organization h checks the trading price of the trading target region 30 at CO₂ emission date and time from date and time data e obtained from the moving body 10, and sets a cost i corresponding to the second CO₂ emission amount f as the consideration of the emission right based on the trading price. In this case, when the second CO₂ emission amount f increases, the cost i increases. Incidentally, the date and time data e is measured by the position information service such as a GPS together with the position data d.

The trading price fluctuates according to the environmental information of each region. The environmental information includes information regarding weather. For example, in a region with bad weather that affects the traveling of the moving body 10, such as when a typhoon has occurred, the trading price is lowered below that in a normal time (when the weather is good). Accordingly, the transportation operator P2 can determine whether or not to select a low-cost route even though there is a risk. On the other hand, in consideration of safety, the trading price in the bad weather may be raised above that in the normal time. This is because when the trading price is raised, there is a high possibility of selecting another route in terms of cost even though the convenience of the route passing through the region is high.

The environmental information includes information regarding construction on the travel route. For example, when construction that affects the traveling of the moving body 10 is performed, the trading price is lowered below that at the normal time (when normal traveling is possible). Conversely, in order to avoid traffic congestion, the trading price during construction may be raised above that at the normal time. This is because when the trading price is raised, there is a high possibility of selecting another route in terms of cost even though the convenience of the route passing through the region is high.

The environmental information includes information regarding traffic congestion on the travel route. For example, when traffic congestion that affects the traveling of the moving body 10 occurs, the trading price is lowered below that at the normal time (when normal traveling is possible). Conversely, for the purpose of alleviating traffic congestion (reducing traffic volume), the trading price in traffic congestion may be raised above that at the normal time. This is because when the trading price is raised, there is a high possibility of selecting another route in terms of cost even though the convenience of the route passing through the region is high.

The trading price includes a first trading price for an economic region and a second trading price for a non-economic region. The “economic region” refers to a region under the jurisdiction of each country, and is an exclusive economic zone in the case of international marginal transportation. The “non-economic region” refers to a region outside the jurisdiction of each country, and corresponds to the high sea or the like in the case of international marginal transportation.

In the current international marginal transportation, there is no regulation on CO₂ emitted in the exclusive economic zone/high sea. For this reason, the number of users who increase the traveling speed in the non-economic region (high sea) in order to shorten the transportation time and the like increases. In order to regulate malicious traveling in such a non-economic region, it is preferable to determine the emissions trading scheme g including the non-economic region.

The first trading price for the economic region is set individually by each country. For example, the first trading price may be raised above that in the jurisdiction region of another country for the purpose of regulating traveling in the jurisdiction region of the own country. Conversely, the first trading price may be lowered below that in the jurisdiction region of another country for the purpose of revenue of emission rights or the like.

The second trading price for the non-economic region may be set to be lower than the first trading price. For example, when the moving body 10 has a hybrid function capable of switching between motor driving and engine driving, the traveling is performed by motor driving in the economic region, and the traveling is performed by engine driving in the non-economic region, whereby the cost of the emission right can be suppressed. The cost obtained in the non-economic region may be allocated to a neighboring developing country in the relevant region, for example. The allocation destination of the cost is not limited to the neighboring developing country, and may be any developing country registered in the international organization h in advance. In addition, the second trading price may be set high in order to increase the allocation to developing countries.

When the cost i corresponding to the second CO₂ emission amount f is set by the international organization h, the cost is presented to a CO₂ emission manager. As a presentation method, a method of sending information of the cost i corresponding to the emission right together with the amount of CO₂ emitted by the moving body 10 and information of the region (the second CO₂ emission amount f and the trading target region 30) to the terminal device of the CO₂ emission manager can be considered.

The “CO₂ emission manager” is an operator, an association, or the like subject to the CO₂ emission regulation, and is a person who has an obligation to pay for the emission right according to the CO₂ emission amount of the moving body 10. In the example of FIG. 1, the transportation operator P2 corresponds to the CO₂ emission manager. The international organization h distributes an amount j obtained by subtracting a commission or the like from the cost i paid by the transportation operator P2 to the trading target region 30.

Incidentally, for example, virtual currency using blockchain technology or the like may be used as a trading method of emission rights. In addition, in a case where an offset obligation is imposed on the transportation operator P2, a deduction amount corresponding to the offset for the transportation operator P2 is set in the international organization h. In this case, the international organization h charges the transportation operator P2 with the amount obtained by deducting the offset due to the CO₂ reduction measure from the cost i corresponding to the second CO₂ emission amount f. As the CO₂ reduction measure, in aviation products, a bio-jet fuel (fuel using algae, city waste, non-edible plants, and the like as raw materials) is used as an alternative fuel. In automobile products and marine products, fuel (biofuels, methanol, ammonia, hydrogen, or the like) having a low environmental load may be used in addition to CO₂ reduction measures based on the conversion to electric vehicles (EV) and fuel cell vehicles (FCV).

Next, a specific configuration for realizing a carbon dioxide emissions trading method will be described.

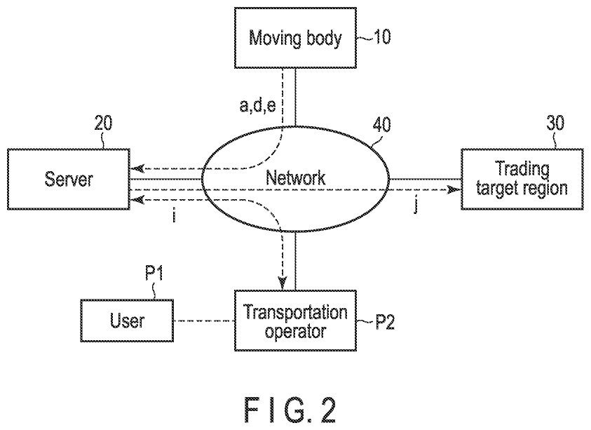

FIG. 2 is a diagram schematically illustrating a configuration of an emissions trading system according to this embodiment.

The server 20 is connected to the moving body 10, the transportation operator P2, and the trading target region 30 via a network 40. Incidentally, in the example of FIG. 2, the moving body 10, the transportation operator P2, and the trading target region 30 are connected to the network 40 for convenience of description, but are actually connected to the network 40 via a terminal device provided in the moving body 10, a terminal device possessed by the transportation operator P2, a terminal device installed in the trading target region 30, or the like.

During the traveling of the moving body 10, the first CO₂ emission amount a, the position data d, and the date and time data e are sent to the server 20 via the network 40. The server 20 specifies the trading target region 30 based on the first CO₂ emission amount a and the position data d, and obtains the second CO₂ emission amount f indicating the amount of CO₂ emitted by the moving body 10 in the trading target region 30. In addition, the server 20 determines the trading price at the CO₂ emission date and time defined in the emissions trading scheme g of the trading target region 30 based on the date and time data e, and sets the cost i corresponding to the second CO₂ emission amount f as the consideration of the emission right based on the trading price. The server 20 presents the cost i to the transportation operator P2, and distributes the amount j obtained by subtracting the commission or the like from the cost i paid by the transportation operator P2 to the trading target region 30.

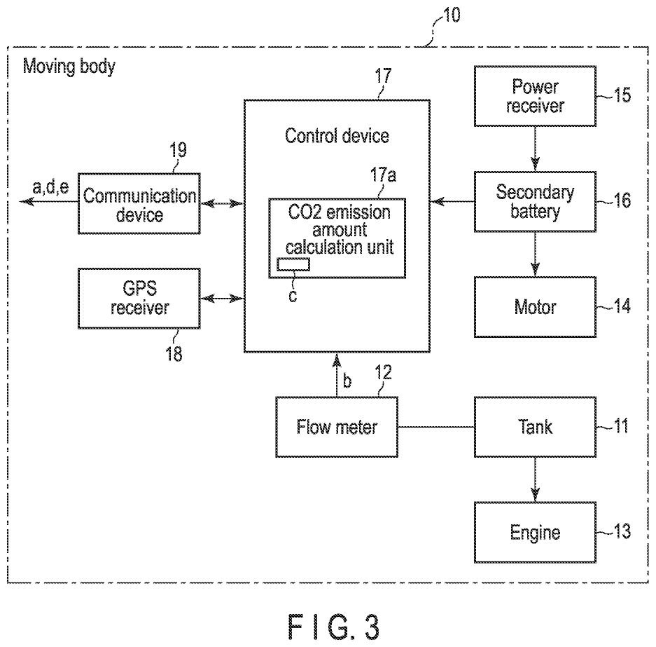

FIG. 3 is a block diagram illustrating a functional configuration of the moving body 10. Incidentally, in the example of FIG. 3, the configuration of the hybrid type moving body 10 including the engine 13 and the motor 14 is illustrated, but the moving body 10 including only the engine 13 may be used.

The moving body 10 includes a power receiver 15 for wireless charging and a secondary battery 16 that stores the electric power received from the power receiver 15. The secondary battery 16 is, for example, LiB (lithium-ion battery). The electric power stored in the secondary battery 16 is used when the motor 14 is driven, and is also used as operating power of each unit including the control device 17. Incidentally, the engine 13 may act as a generator to charge the secondary battery 16.

When the moving body 10 travels by the driving of the motor 14, the emission amount of CO₂ is 0. On the other hand, when the moving body 10 travels by the driving of the engine 13, CO₂ is emitted by the combustion of the fuel stored in a tank 11. The fuel consumption amount b is measured by the flow meter 12 and given to the control device 17.

The control device 17 includes a computer (CPU), and executes the driving control and the like of the moving body 10. The control device 17 includes a CO₂ emission amount calculation unit 17a. The CO₂ emission amount calculation unit 17a calculates the amount of CO₂ emitted by the moving body 10 during traveling as the first CO₂ emission amount a based on the fuel consumption amount b measured by the flow meter 12 during traveling and the CO₂ emission amount c per unit amount of the fuel.

The moving body 10 includes a GPS receiver 18 and a communication device 19. The GPS receiver 18 detects the current position of the moving body 10 from a GPS signal and detects the current date and time. The communication device 19 functions as a data transmission unit that transmits the position data d obtained receiver 18 and the date and time data e by the GPS to the server 20 together with the first CO₂ emission amount a.

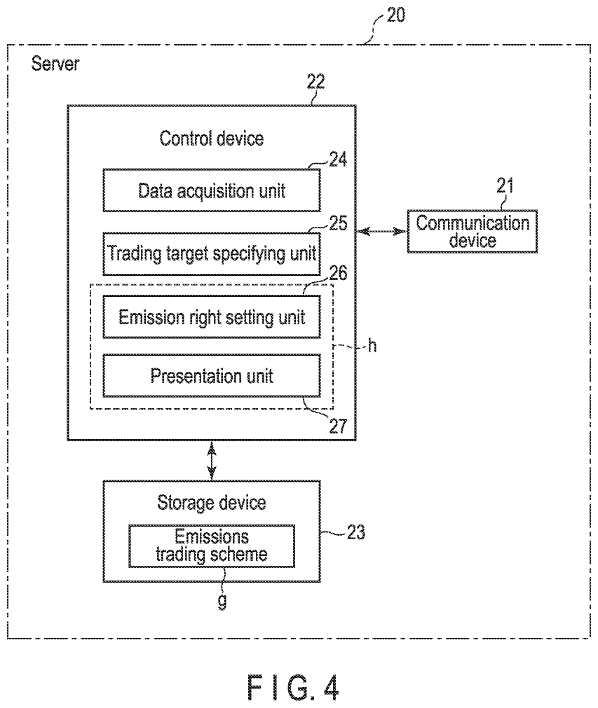

FIG. 4 is a block diagram illustrating a functional configuration of the server 20.

The server 20 includes a communication device 21, a control device 22, and a storage device 23. The communication device 21 functions as a transmission/reception unit of data exchanged with the moving body 10, the transportation operator P2, and the trading target region 30 via the network 40.

The control device 22 includes a computer (CPU), and executes processing relating to CO₂ emissions trading. Specifically, the control device 22 includes a data acquisition unit 24, a trading target specifying unit 25, an emission right setting unit 26, and a presentation unit 27.

The data acquisition unit 24 acquires the position data d indicating the current position of the moving body 10 and the first CO₂ emission amount a indicating amount of CO₂ emitted by the moving body 10 during traveling. In addition, the data acquisition unit 24 acquires the date and time data e indicating the CO₂ emission date and time together with the position data d. Based on the position data d and the first CO₂ emission amount a obtained by the data acquisition unit 24, the trading target specifying unit 25 specifies, as the trading target region, a region where the moving body 10 is traveling among the plurality of regions divided in terms of rights, and obtains the second CO₂ emission amount f emitted in the trading target region.

The emission right setting unit 26 and the presentation unit. 27 perform processing relating to the international organization h illustrated in FIG. 1. The emission right setting unit 26 reads the scheme information of the trading target region from the emissions trading scheme g of each region stored in the storage device 23. This scheme information includes the trading price of the emission right. The emission right setting unit 26 determines the trading price at the CO₂ emission date and time based on the date and time data e, and sets the cost corresponding to the second CO₂ emission amount f as the consideration of the emission right. The presentation unit 27 presents the cost corresponding to the second CO₂ emission amount f to the transportation operator P2 who is the CO₂ emission manager, and causes the transportation operator P2 and the trading target region 30 to trade the emission right with each other.

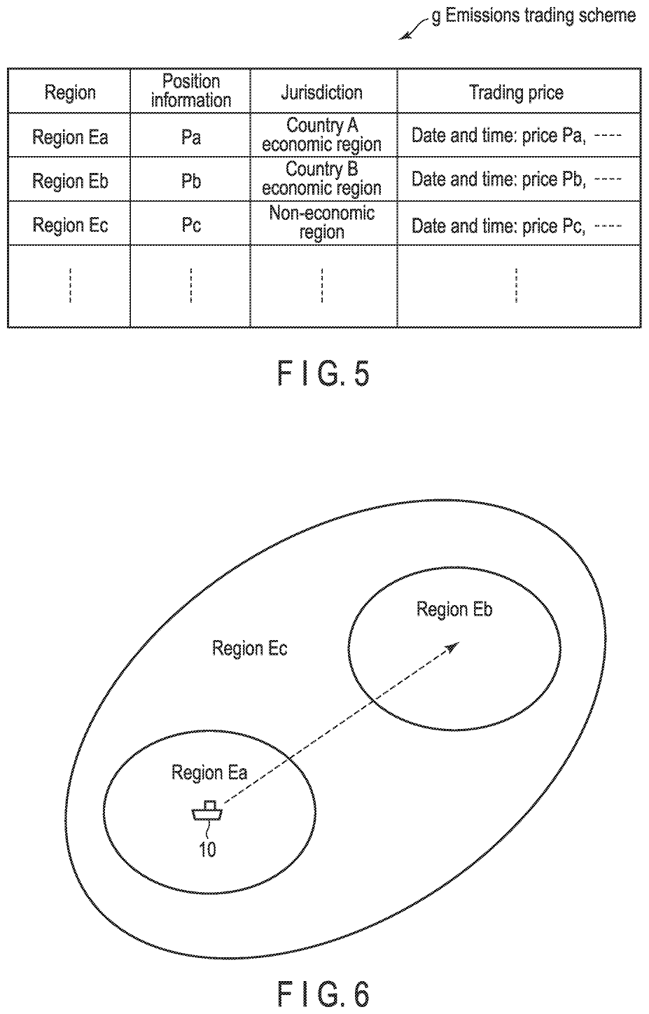

The storage device 23 stores various types of data necessary for the processing operation of the control device 22. As illustrated in FIG. 5, the storage device 23 stores scheme information regarding the emissions trading scheme g of each region. As illustrated in FIG. 6, the scheme information includes, for each region (Ea, Eb, Ec, and so on), information such as the position information (Pa, Pb, Pc, and so on), the jurisdiction (economic region/non-economic region), and the trading price ($a, $b, $c, and so on) of the region. As described above, the trading price fluctuates according to the environmental information (including weather information, construction information, and congestion information) of each region, and the current amount is appropriately updated and stored in the storage device 23.

(Hardware Configuration)

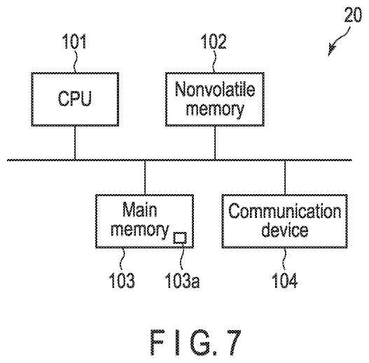

FIG. 7 is a diagram illustrating an example of a hardware configuration of the server 20.

The server 20 includes, as hardware components, a CPU 101, a nonvolatile memory 102, a main memory 103, a communication device 104, and the like.

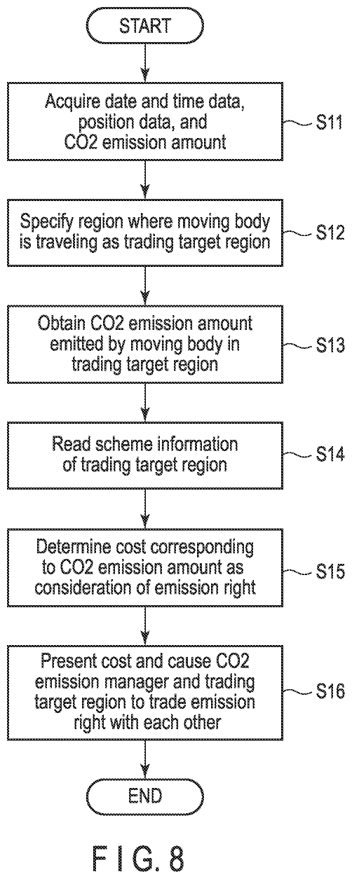

The CPU 101 is a hardware processor that controls the operation of the control device 22 illustrated in FIG. 4. The CPU 101 executes various programs loaded from the nonvolatile memory 102 as a storage device to the main memory 103. The program executed by the CPU 101 includes a program (hereinafter, referred to as an emissions trading program) 103a for executing the processing operation illustrated in the flowchart of FIG. 8 in addition to an operating system (OS).

The data acquisition unit 24, the trading target specifying unit 25, the emission right setting unit 26, and the presentation unit 27 illustrated in FIG. 6 are realized by causing the CPU 101 as a computer to execute the emissions trading program 103a. The emissions trading program 103a may be stored in a computer-readable storage medium and distributed, or may be downloaded to another computer through a network. Incidentally, some or all of the data acquisition unit 24, the trading target specifying unit 25, the emission right setting unit 26, and the presentation unit 27 may be realized by hardware such as an integrated circuit (IC), or may be realized as a combination configuration of the relevant software and the hardware.

The nonvolatile memory 102 and the main memory 103 correspond to the storage device 23 illustrated in FIG. 4. The communication device 104 is, for example, a device configured to execute wired or wireless communication with an external device, and corresponds to the communication device 21 in FIG. 4.

Incidentally, the same applies to the computers used for the moving body 10, the transportation operator P2, and the trading target region 30, and the CPU reads a predetermined program to execute processing corresponding to each.

Hereinafter, it is assumed that the moving body 10 is a ship, and emission right acquisition processing of CO₂ emitted during traveling in each region will be described.

FIG. 8 is a flowchart illustrating a flow of the emission right acquisition processing in the emissions trading system. The processing illustrated in this flowchart is mainly executed by the control device 22 provided in the server 20. Specifically, the CPU 101 (microprocessor) that realizes each function (the data acquisition unit 24, the trading target specifying unit 25, the emission right setting unit 26, and the presentation unit 27) included in the control device 22 reads the emissions trading program 103a to execute the program.

The server 20 acquires the date and time data e, the position data d, and the first CO₂ emission amount a transmitted from the moving body 10 during traveling (step S11), specifies, as the trading target region, the region where the moving body 10 is traveling based on the position data d (step S12), and obtains the second CO₂ emission amount f emitted in the relevant trading target region based on the first CO₂ emission amount a (step S13). For example, when the moving body 10 is traveling in a region Ea illustrated in FIG. 6, the region Ea is specified as the trading target region 30. Then, the amount of CO₂ emitted in the region Ea, that is, the second CO₂ emission amount f is obtained by integrating the first CO₂ emission amount a emitted while the moving body 10 is traveling in the region Ea.

Here, the server 20 has the function of the international organization h illustrated in FIG. 1, and reads scheme information regarding the trading target region 30 from the emissions trading scheme g of each region (step S14). The scheme information includes the trading price of the emission right determined for each region, and the trading price varies depending on whether the trading target region 30 belongs to the economic region (exclusive economic zone) or the non-economic region (high sea or the like).

For example, it is assumed that as illustrated in FIG. 6, the region Ea and the region Eb are the economic regions, and the region Ec is the non-economic region. The trading price relating to the emission right of CO₂ emitted while the moving body 10 travels in the region Ea is determined by a country A having jurisdiction over the region Ea. Similarly, the trading price relating to the emission right of CO₂ emitted while the moving body 10 travels in the region Eb is determined by a country B having jurisdiction over the region Eb. On the other hand, the trading price relating to the emission right of CO₂ emitted while the moving body 10 travels in the region Ec is arbitrarily set in consideration of the price trend of each country and the like.

The server 20 determines the trading price of the trading target region 30 at the CO₂ emission date and time from the date and time data e acquired from the moving body 10, and sets the cost i corresponding to the second CO₂ emission amount f as the consideration of the emission right based on the trading price (step S15). For example, when the moving body 10 travels in the region Ea by engine driving, the date and time data sent from the moving body 10 during the traveling indicates the CO₂ emission date and time. A trading price $a of the region Ea at the CO₂ emission date and time may be read from the emissions trading scheme g illustrated in FIG. 5, and the cost i corresponding to the second CO₂ emission amount f may be set as the consideration of the emission right for the region Ea based on the trading price $a.

Here, in a case where an offset obligation is imposed on the transportation operator P2 who is the CO₂ emission manager, the amount obtained by deducting the offset due to the CO₂ reduction measure from the cost i corresponding to the second CO₂ emission amount f is set as a final cost. The deduction amount corresponding to the offset is determined in advance at an international conference or the like, and is stored in the storage device 23 illustrated in FIG. 4.

The server 20 presents the cost i (or the final cost obtained by deducting the offset) corresponding to the second CO₂ emission amount f to the transportation operator P2, thereby causing the transportation operator P2 and the trading target region 30 to trade the emission right with each other (step S16). Specifically, the server 20 sends information regarding the cost i of emitting CO₂ in the trading target region 30 to the terminal device of the transportation operator P2 via the network 40. Then, when receiving the cost i paid by the transportation operator P2, the server 20 distributes the amount j obtained by subtracting the commission or the like from the cost i to the trading target region 30.

Incidentally, for example, virtual currency using blockchain technology or the like may be used for trading processing of emission rights between the transportation operator P2 and the trading target region 30 in addition to the presentation of the cost i to the transportation operator P2 and the distribution of the amount j to the trading target region 30.

In a case where the trading target region 30 is the non-economic region, the cost i obtained in the non-economic region may be allocated to a neighboring developing country in the relevant region. Distribution information indicating the distribution destination of the cost i obtained in each region including the non-economic region is stored in advance in the storage device 23 of the server 20, and the trading processing is performed according to the distribution information.

As described above, according to this embodiment, the emission amount of CO₂ emitted by the moving body 10 in the trading target region is obtained based on the position of the moving body 10 during traveling and the emission amount of CO₂, and the cost corresponding to the emission amount is set as the consideration of the emission right and presented to the CO₂ emission manager, whereby the responsibility for the CO₂ emission becomes clear, and the CO₂ emission manager can be charged the consideration corresponding to the emission right. Accordingly, the CO₂ emission manager considers, for example, operational measures such as reducing the traveling speed or the electrification of the moving body 10 as a measure for reducing an emission right cost, and thus the CO₂ emission amount is expected to be reduced.

Incidentally, in this embodiment, a ship has been described as an example of the moving body 10, but the same applies to, for example, an automobile and a flight vehicle. In short, as long as the moving body such as transportation emits CO₂ during traveling, the present invention can be applied to each region where the moving body travels as the trading target of the emission right.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A carbon dioxide emissions trading method comprising:
acquiring position data indicating a current position of a moving body and a first CO₂ emission amount indicating an amount of CO₂ emitted by the moving body during traveling;
specifying one region, where the moving body is traveling, of a plurality of regions divided in terms of rights as a trading target region based on the position data and the first CO₂ emission amount and obtaining a second CO₂ emission amount indicating an amount of CO₂ emitted by the moving body in the trading target region;
setting a cost corresponding to the second CO₂ emission amount as a consideration of an emission right based on scheme information regarding emissions trading in the trading target region; and
trading the emission right between a CO₂ emission manager and the trading target region based on the cost corresponding to the second CO₂ emission amount.

2. The carbon dioxide emissions trading method according to claim 1, wherein an amount obtained by deducting an offset due to a CO₂ reduction measure from the cost corresponding to the second CO₂ emission amount is set as a final cost.

3. The carbon dioxide emissions trading method according to claim 1, wherein
the scheme information includes a trading price of an emission right determined in the trading target region, and
when date and time data when the moving body emits CO₂ in the trading target region is acquired, a cost corresponding to the emission right is set from the trading price of the trading target region at the CO₂ emission date and time.

4. The carbon dioxide emissions trading method according to claim 3, wherein the trading price fluctuates according to environmental information of each of the regions.

5. The carbon dioxide emissions trading method according to claim 4, wherein
the environmental information includes information regarding weather, and
the trading price is raised or lowered in the weather which affects traveling of the moving body.

6. The carbon dioxide emissions trading method according to claim 4, wherein
the environmental information includes information regarding construction on a travel route, and
the trading price is raised or lowered when the construction which affects traveling of the moving body is performed.

7. The carbon dioxide emissions trading method according to claim 4, wherein
the environmental information includes information regarding a traffic congestion on a travel route, and
the trading price is raised or lowered when the traffic congestion which affects traveling of the moving body occurs.

8. The carbon dioxide emissions trading method according to claim 3, wherein
the trading price includes a first trading price for an economic region and a second trading price for a non-economic region,
the cost corresponding to the emission right is set in accordance with the first trading price when the moving body is traveling in the economic region, and
the cost corresponding to the emission right is set in accordance with the second trading price when the moving body is traveling in the non-economic region.

9. The carbon dioxide emissions trading method according to claim 8, wherein the cost obtained in the non-economic region is distributed to a developing country.

10. The carbon dioxide emissions trading method according to claim 1, wherein the first CO₂ emission amount is calculated based on a consumption amount of a fuel and a CO₂ emission amount per unit amount of the fuel when the moving body travels by engine driving.

11. A carbon dioxide emissions trading system comprising a server connected to a moving body via a network,
the server including a memory storing scheme information regarding emissions trading of each region, and a hardware processor connected to the memory,
the hardware processor performing:
acquiring position data indicating a current position of the moving body and a first CO₂ emission amount indicating CO₂ emitted by the moving body during traveling;
specifying one region, where the moving body is traveling, of a plurality of regions divided in terms of rights as a trading target region based on the position data and the first CO₂ emission amount and obtaining a second CO₂ emission amount emitted in the trading target region;
reading the scheme information regarding emissions trading of each region from the memory and setting a cost corresponding to the second CO₂ emission amount as a consideration of an emission right based on the scheme information; and
presenting the cost corresponding to the second CO₂ emission amount to a CO₂ emission manager.

12. The carbon dioxide emissions trading system according to claim 11, wherein
the hardware processor performs setting, as a final cost, an amount obtained by deducting an offset due to a CO₂ reduction measure from the cost corresponding to the second CO₂ emission amount.

13. The carbon dioxide emissions trading system according to claim 11, wherein
the scheme information includes a trading price of an emission right determined in the trading target region, and
the hardware processor performs, when date and time data when the moving body emits CO₂ in the trading target region is acquired, setting a cost corresponding to the emission right from the trading price of the trading target region at the CO₂ emission date and time.

14. The carbon dioxide emissions trading system according to claim 13, wherein the trading price fluctuates according to environmental information of each of the regions.

15. The carbon dioxide emissions trading system according to claim 14, wherein
the environmental information includes information regarding weather, and
the trading price is raised or lowered in the weather which affects traveling of the moving body.

16. The carbon dioxide emissions trading system according to claim 14, wherein
the environmental information includes information regarding construction on a travel route, and
the trading price is raised or lowered when the construction which affects traveling of the moving body occurs.

17. The carbon dioxide emissions trading system according to claim 14, wherein
the environmental information includes information regarding a traffic congestion on a travel route, and
the trading price is raised or lowered when the traffic congestion which affects traveling of the moving body occurs.

18. The carbon dioxide emissions trading system according to claim 14, wherein
the scheme information includes a first trading price for an economic region and a second trading price for a non-economic region, and
the hardware processor performs
setting the cost corresponding to the second CO₂ emission amount as the consideration of the emission right in accordance with the first trading price when the moving body is traveling in the economic region, and
setting the cost corresponding to the second CO₂ emission amount as the consideration of the emission right in accordance with the second trading price when the moving body is traveling in the non-economic region.

19. A moving body comprising:
a power receiver for wireless charging;
a secondary battery that stores electric power received from the power receiver; and
a communication device that transmits position data indicating a current position, date and time data indicating current date and time, and data of CO₂ emission amount during traveling to a server that performs trading processing of an emission right.

20. The moving body according to claim 19, wherein
the moving body has a function capable of traveling with changeover between a motor driven by the electric power stored in the secondary battery and an engine driven by a fuel, and
the CO₂ emission amount data is calculated based on a consumption amount of the fuel and a CO₂ emission amount per unit amount of the fuel when the moving body travels by driving of the engine.
